(19) United States
(12) Patent Application Publication
(10) Pub. No.: US 2022/0129910 A1
(43) Pub. Date: Apr. 28, 2022

(54) METHOD AND SYSTEM FOR MANAGING HACCP IMPLEMENTATION CHECK

(71) Applicants: Jin Seo PARK, Seoul (KR); MASICGONG CORP., Seoul (KR)

(72) Inventor: Jin Seo PARK, Seoul (KR)

(21) Appl. No.: 17/293,465

(22) PCT Filed: Nov. 11, 2019
(86) PCT No.: PCT/KR2019/015235

§ 371 Date: May 12, 2021

(30) Foreign Application Priority Data
Nov. 15, 2018 (KR) 10-2018-0140779

(51) Int. Cl. G06Q 30/00; G06Q 10/06

(52) U.S. Cl. CPC G06Q 30/018; G06Q 10/067

(57) ABSTRACT

The present invention relates to a method and a system for managing HACCP implementation check and, more specifically, to a method and a system for managing HACCP implementation check that may provide an implementation notification to an implementation manager according to a schedule table by documenting a HACCP implementation checklist in a cloud to implement HACCP certification requirements in a food factory. To this end, the HACCP implementation check management method according to the present invention is a HACCP implementation check management method performed by a cloud server in the HACCP implementation check management system.

### CROSS-REFERENCE TO RELATED APPLICATIONS

This application claims the benefit under 35 U.S.C. section 371, of PCT International Application No. PCT/KR2019/015235, filed on Nov. 11, 2019, which claims foreign priority to Korean Patent Application No. 10-2018-0140779, filed on Nov. 15, 2018, in the Korean Intellectual Property Office, the disclosures of which are hereby incorporated by reference in their entireties.

### TECHNICAL FIELD

The present disclosure relates to a method and a system for managing HACCP implementation check, and more particularly, to a method and a system for managing HACCP implementation check, which can document a HACCP implementation checklist in a cloud and can provide an implementation notification to an implementation manager according to a schedule table, so that HACCP certification requirements can be implemented in a food factory.

### BACKGROUND ART

Hazard Analysis Critical Control Point (HACCP) is a scientific hygiene management system that secures food safety by identifying hazards which may occur at respective steps from the production of raw materials of foods to the intake by consumers through the manufacturing, processing, preserving, distributing of foods, determining critical control points for focusing management of the hazards, and managing the critical control points independently, systematically and efficiently. This method is called ‘HACCP’ and is interpreted as food hazard critical management requirements in the Korea Food & Drug Administration.

The HACCP is divided into hazard analysis (HA) and critical control points (CCP). The HA is finding, analyzing, and evaluating all possible factors that lead to hazards to raw materials and production process, and the CCP refers to management points that should be dealt with in priority to prevent and eliminate corresponding hazards and to secure safety.

In Korea, the introduction of HACCP had been prepared since 1992, and the HACCP was first introduced under the Food Sanitation Act in December 1995. In addition, a legal basis to mandatorily apply the HACCP was established in 2002, and, in 2006, seven items including: fish cakes of processed fish products; three kinds of frozen marine products such as fish, invertebrates, flavor-treated processed products; three kinds of frozen foods such as pizza, dumplings, noodles; ice-creams; non-pasteurized beverages; retort food products; and Kimchi cabbage (since Dec. 1, 2008) were designated as mandatory HACCP-applied items, and the mandatory items have increased sequentially every year, based on the annual sales and the number of employees in business entities.

According to current data of HACCP certification from the last fiver years, types of food businesses that should apply HACCP certification include food processing businesses (manufacturing businesses, instant food sales, manufacturing, processing businesses), food subdivision distribution businesses, agricultural, livestock, or fishery product production and aquaculture businesses, restaurant businesses. However, in June of this year, only 8,598 businesses in total received HACCP certification on food manufacturing and livestock processing products, and this is merely 21.1% of the total number of food manufacturers, 39,951, in the year 2016.

The 8 HACCP-applied items are snacks/candies, breads/rice cakes, chocolates, fish sausages, beverages, instant foods, noodles/instant fried noodles, special purpose foods, and the Ministry of Food and Drug Safety are promoting expansion of the mandatory HACCP application on the 8 items in 4 stages to 2020. The first stage (enforced from December 2014) was targeted at businesses having sales over two billion won in the year 2013 and having over 51 employees, and the second stage (enforced from December 2016) was targeted at businesses having sales over 500 million and having over 21 employees. The third stage which will be enforced from December 2018 is targeted at businesses having sales over one hundred million and having over 6 employees, and the fourth stage which will be enforced from December 2020 is applied to businesses to which the first to third stages are not applied.

If the fourth stage, which will be enforced in 2020, is applied this year, 5,609 businesses which are 87.1% of 6,439 target businesses would be regarded as non-certified businesses. About 80% of the companies in Korea are small businesses belonging to the third or fourth stages, and accordingly, there is a need for human resources and budget support for helping financial support in improving and repairing facilities of small businesses, technical assistance, certification screening, and strengthening post management.

According to results of periodically evaluating HACCP enterprises and a current state of unconformity, a non-compliance rate is still high, and the result of periodically evaluating in 2017 shows that 267 enterprises which are 7.8% of 3,419 enterprises did not comply with the HACCP management requirements, and the result in the first half of the year 2018 shows that 144 enterprises which are 6.6% of 2188 enterprises do not comply with the HACCP management requirements.

To implement the HACCP certification requirements, a method for efficiently maintaining a record by documenting the HACCP system is required. The record maintenance is an essential element for the HACCP system, and the operation of the HACCP system without record maintenance may be inefficient and may not guarantee operation grounds. Therefore, there is a demand for development and maintenance of a record regarding operation of an HACCP plan.

One of the methods of approaching development of a record maintenance method for the HACCP system is reviewing a previous record that has been maintained and managed. The best record maintenance system is a system that integrates recorded necessary contents simply and intelligibly. That is, when a record maintenance method is developed, a simple record format that can most easily be understood should be developed by considering an optimal record manager and a reviewer, recording time and period, storage period and place of a record, etc.

However, in a food factory of an HACCP certification company, there may be cumbersome and inconvenient processes of completing various documents in the HACCP system, that is, a checklist which is a document for recording results of implementing the HACCP, daily, weekly, monthly, annually, in order to implement HACCP certification requirements. Completing such a HACCP checklist in the workplace every time may become a great burden to a manager of the food factory, and also, when the manager forgets a completion schedule or does not complete according to a format, there may be a problem that the HACCP management requirements are not complied with.

### DISCLOSURE

### Technical Problems

The present disclosure has been developed in order to solve the above-mentioned problems, and an object of the present disclosure is to provide a method for a manager of a HACCP certification company to implement HACCP certification requirements easily without a work burden.

Another object of the present disclosure is to provide an integrated service that can transmit, to a manager, a HACCP implementation checklist suitable for a manufacturing process or a facility environment of a HACCP certification company according to an implementation check date, and enables a document satisfying HACCP implementation conditions to be finally submitted to a HACCP management agency.

### Technical Solution

To achieve the objects, a HACCP implementation check management method according to the present disclosure is a HACCP implementation check management method which is performed by a cloud server in a HACCP implementation check management system, and includes: a step of generating and saving a common checklist questionnaire having a question-answer format by disassembling a common checklist; a step of generating and saving a differential checklist questionnaire having a question-answer format by disassembling a differential checklist; a step of generating an implementation checklist questionnaire from the common checklist questionnaire and the differential checklist questionnaire, on the basis of a task implementation designation schedule table for each customer included in HACCP requirements information of a HACCP certification company; a step of transmitting the implementation checklist questionnaire to an implementation manager terminal of the HACCP certification company; a step of receiving answers to the implementation checklist questionnaire from the implementation manager terminal, and generating and saving an implementation checklist confirmation document; and a step of generating and saving an approval document regarding the implementation checklist confirmation document when the implementation checklist confirmation document is approved by an approver terminal of the HACCP certification company.

In addition, an application for HACCP implementation check management according to the present disclosure is an application for HACCP implementation check management which is saved in a computer-readable recording medium, and performs: a step of receiving an implementation checklist questionnaire comprising a common checklist questionnaire and a differential checklist questionnaire from a cloud server when an implementation check date comes; a step of processing the received implementation checklist questionnaire, and providing implementation check questions and answer fields thereto; and a step of transmitting answers to the implementation checklist questionnaire to the cloud server when the answers to the implementation checklist questionnaire are completed.

In addition, a HACCP implementation check management system according to the present disclosure includes: a cloud server configured to generate a common checklist questionnaire having a question-answer format by disassembling a common checklist, to generate and save a differential checklist questionnaire having a question-answer format by disassembling a differential checklist, and to generate an implementation checklist questionnaire from the common checklist questionnaire and the differential checklist questionnaire, on the basis of a task implementation designation schedule table for each customer included in HACCP requirements information of a HACCP certification company; an implementation manager terminal configured to receive the implementation checklist questionnaire from the cloud server every time an implementation check date comes, and to transmit answers to the implementation checklist questionnaire to the cloud server; and a computer of the HACCP certification company configured to connect to the cloud server and to transmit the HACCP requirements information of the HACCP certification company to the cloud server.

### Advantageous Effects

According to the present disclosure as described above, when a HACCP certification company inputs HACCP requirements information through a web site, a HACCP manager can receive a HACCP implementation task schedule through an application at an implementation check date, and can identify the same and can answer to questions of the HACCP implementation checklist. The HACCP certification company can comply with HACCP management requirements when an approver approves.

That is, the difficulties that a small food company may encounter in managing certification after HACCP certification is obtained may be having to complete checklists, which are 15 HACCP implementation result documents to the maximum, daily, weekly, monthly, annually, and may be forgetting a task schedule in this process or having to complete printed checklists in the workplace. According to the present disclosure, a HACCP implementation task can be processed cheaply and easily through the HACCP implementation check management service.

Accordingly, food companies can noticeably reduce a work load and a task processing cost by using the HACCP implementation check management service according to the present disclosure, and consumers can consume more safe foods, and as a result, there is an effect of contributing to national health.

### BRIEF DESCRIPTION OF DRAWINGS

FIG. 1 is a schematic configuration diagram of a HACCP implementation check management system according to the present disclosure;

FIG. 2 is a schematic inner configuration diagram of a cloud server according to the present disclosure;

FIG. 3 is a flowchart of processing in a HACCP implementation check management system according to the present disclosure;

FIG. 4 is a sequence diagram illustrating a processing process for managing HACCP implementation check in the cloud server according to the present disclosure;

FIG. 5 is a view illustrating a HACCP implementation checklist questionnaire according to the present disclosure; and

FIGS. 6A and 6B are views illustrating a screen displayed on an implementation manager terminal which receives a HACCP implementation check management service according to the present disclosure.

### DETAILED DESCRIPTIONS

Hereinafter, embodiments according to the present disclosure will be described in detail with reference to the accompanying drawings. A configuration of the present disclosure and an effect resulting therefrom will be clearly understood based on the following detailed descriptions.

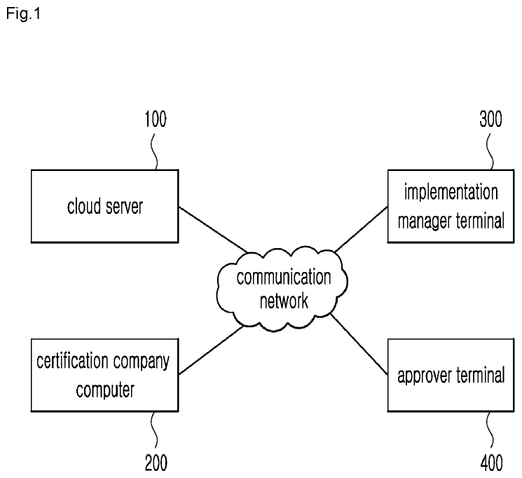

FIG. 1 illustrates a schematic configuration of a HACCP implementation check management system according to the present disclosure.

Referring to FIG. 1, the HACCP implementation check management system may include a cloud server 100, a certification company computer 200, an implementation manager terminal 300, an approver terminal 400, etc.

The cloud server 100 is a management device that is owned by a HACCP management agency. The cloud server 100 generates a HACCP implementation checklist questionnaire, on the basis of HACCP requirements information inputted by the certification company computer 200, and provides the same to the implementation manager terminal 300.

The cloud server 100 receives answers to the implementation checklist questionnaire from the implementation manager terminal 300, and generates an implementation checklist confirmation document. In addition, when the implementation checklist confirmation document is approved by the approver terminal 400, the cloud server 100 generates and saves an approval document regarding the implementation checklist confirmation document.

The certification company computer 200 is a computer that is used by a company that obtains HACCP certification. The certification company computer 200 logs into the cloud server 100 and inputs HACCP requirements information which is received when HACCP certification is obtained.

The implementation manager terminal 300 is a terminal that is owned by a HACCP implementation check manager of the HACCP certification company. The implementation manager terminal 300 is a portable terminal like a smartphone, a tablet PC, or the like. The implementation manager terminal 300 receives the implementation checklist questionnaire from the cloud server 100 and transmits answers to the implementation checklist questionnaire to the cloud server 100.

The approver terminal 400 is a terminal that is owned by a HACCP implementation check approver of the HACCP certification company. The approver terminal 400 may be the certification company computer 200 or other computers, or may be a portable terminal like the implementation manager terminal 300. Since entities of management and approval of implementation check should be separated, the approver terminal 400 should not be the same as the implementation manager terminal 300 if the approver terminal 400 is a portable terminal.

The approver terminal 400 requests and reads the implementation checklist confirmation document saved in the cloud server 100, and approves the implementation checklist confirmation document. When the implementation checklist confirmation document is approved by the approver terminal 400, the cloud server 100 generates and saves an approval document regarding the implementation checklist confirmation document, and then, the certification company computer 200 or the approver terminal 400 may invoke the approval document saved in the cloud server 100 and may transmit the same to the HACCP management agency by email or may upload onto the HACCP management system.

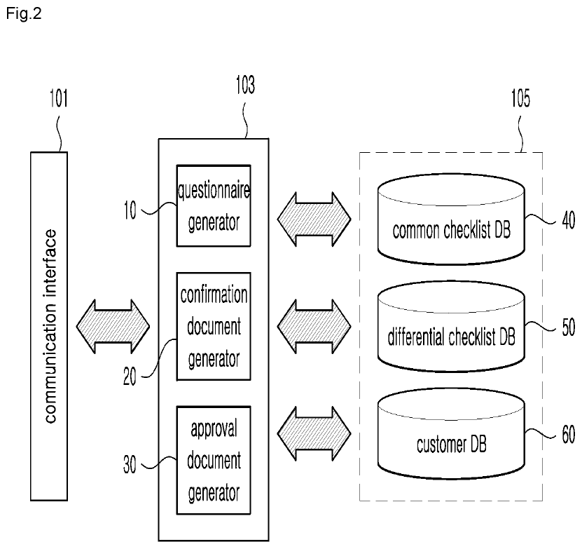

FIG. 2 illustrates a schematic inner configuration of the cloud server according to the present disclosure.

Referring to FIG. 2, the cloud server 100 includes a communication interface 101, a controller 103, a database 105, etc.

The communication interface 101 is a part for performing data communication with the certification company computer 200, the implementation manager terminal 300, the approver terminal 400, etc. The communication interface 101 is a communication module such as Ethernet, etc. that connects to the Internet to perform TCP/IP communication.

The controller 103 is a part for controlling and managing overall operations of the cloud server. The controller 103 performs various functions, and according to an embodiment of the present disclosure, performs functions of generating a questionnaire, generating a confirmation document, generating an approval document, etc.

The controller 103 includes both hardware and software, and the above-described functions of generating the questionnaire, generating the confirmation document, generating the approval document, etc. may be configured by a software module. That is, the controller 103 includes a questionnaire generator 110, a confirmation document generator 20, an approval document generator 30, etc.

The questionnaire generator 10 generates a common checklist questionnaire and a differential checklist questionnaire for HACCP implementation check, and generates an implementation checklist questionnaire for each HACCP certification company by using the common checklist questionnaire and the differential checklist questionnaire.

The common checklist questionnaire and the differential checklist questionnaire may be created in the form of a text file or an audio file. Accordingly, the implementation checklist questionnaire may be provided in the form of a text file or an audio file.

The confirmation document generator 20 generates an implementation checklist confirmation document by processing answers to the implementation checklist questionnaire, which are received from the implementation manager of the HACCP certification company.

The approval document generator 30 generates an approval document regarding the implementation checklist confirmation document when the implementation checklist confirmation document is approved by the approver of the HACCP certification company. The approval document regarding the implementation checklist confirmation document is a document that is submitted to the HACCP management agency.

The database 105 includes a common checklist DB 40, a differential checklist DB 50, a customer DB 60, etc.

The common checklist DB 40 is a database that saves the common checklist questionnaire.

The common checklist refers to an implementation checklist that all HACCP certification companies complete in common to implement HACCP certification requirements. The questionnaire generator 10 generates the common checklist questionnaire having a question-answer format by disassembling the common checklist, and saves the same in the common checklist DB 40.

The differential checklist DB 50 is a database that saves the differential checklist questionnaire.

The differential checklist refers to an implementation checklist that is completed differently by each HACCP certification company according to food processing that should be managed in priority to produce a safe food according to an item, that is, detection of foreign substances or detection of metal. The questionnaire generator 10 generates the differential checklist questionnaire having a question-answer format by disassembling the differential checklist.

The differential checklist, which should be completed by each HACCP certification company, includes critical control points (CCP) that are determined differently according to a type of a food, a manufacturing process, a facility environment, etc. The CCP may be determined through a hazard analysis process.

The hazard analysis is implemented separately for a raw material/minor ingredient described in product details and a process/step grasped in a processing flowchart. Through this process, all possible hazards that may occur in each raw material or minor ingredient and in each process/step are grasped, and a list thereof is created, and inflow paths of the respective hazards and a means for controlling the hazards (prevention means) are grasped and described, and a possibility of occurrence of hazards is evaluated by considering the inflow paths and the controlling means, and a risk is evaluated by considering seriousness resulting therefrom.

When the hazard analysis is finished, the CCP for managing potential hazards existing in the raw material or process of a corresponding product should be determined. The CCP is a final step or process that can prevent, eliminate, or reduce the hazards grasped through the hazard analysis to an acceptable level.

Examples of the CCP in a manufacturing, processing, cooking process of a food are as follows, and the CCP may vary according to a workplace environment such as a manufacturing facility even when the same food is produced.

1) Cooling process to minimize growth of micro-organisms

2) Heat treatment at a specific time and a temperature to extinguish pathogenic microorganisms

3) Adjusting pH and water activity or mixing product ingredients such as medium addition

4) Processing treatment such as filling and sealing a can

5) Process of detecting metallic foreign substances by a metal detector

One good way of determining the CCP is using a degree of determination of the CCP, and the degree of determination is applied to a hazard that is selected as a critical hazard (a target to be identified) as a result of evaluating hazards.

The customer DB 60 is a database that saves information on HACCP certification companies.

The customer DB 60 saves HACCP requirements information of each HACCP certification company, an implementation checklist questionnaire created based on HACCP requirements information, an implementation checklist confirmation document created based on answers to the implementation checklist questionnaire, an approval document created by approving the implementation checklist confirmation document.

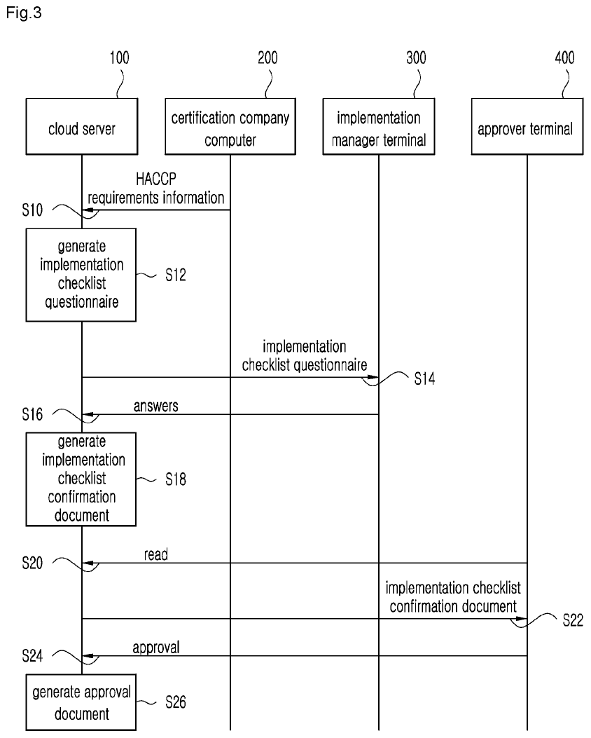

FIG. 3 illustrates a flow of processing in the HACCP implementation checklist management system according to the present disclosure.

Referring to FIG. 3, the cloud server 100 generates a common checklist questionnaire and a differential checklist questionnaire which have a question-answer format by disassembling a common checklist and a differential checklist, respectively, and saves the same in the database 105.

In the state where such a database 105 is established, the HACCP certification company computer 200 logs into the cloud server 100 and inputs HACCP requirements information obtained when HACCP certification is obtained, and requests a HACCP implementation check service (S10).

The HACCP requirements information may include a task implementation designation schedule table according to a food manufacturing process of the HACCP certification company.

When the cloud server 100 receives the HACCP requirements information from the certification company computer 200, the cloud server 100 generates an implementation checklist questionnaire from the common checklist questionnaire and the differential checklist questionnaire, on the basis of the HACCP requirements information (S12).

Next, the cloud server 100 transmits the implementation checklist questionnaire to the implementation manager terminal 300 carried by the implementation manager of the HACCP certification company (S14). The implementation checklist questionnaire may be transmitted daily, weekly, monthly, and quarterly according to the task implementation designation schedule table. Herein, the cloud server 100 may generate the implementation checklist questionnaire every time an implementation check date comes according to the task implementation designation schedule table, and may transmit the same to the implementation manager terminal 300, or may generate and save the implementation checklist questionnaire in advance for all implementation check dates, and may transmit the same to the implementation manager terminal 300 when a corresponding date comes.

When the implementation checklist questionnaire is received from the cloud server 100, the implementation manager terminal 300 processes the implementation checklist questionnaire and provides implementation check questions and answer fields thereto on a screen. The implementation checklist questionnaire may be provided in the form of a text or an audio.

When the implementation manager enters corresponding answers to the answer fields while viewing the implementation checklist questions, the implementation management terminal 300 transmits answer information to the cloud server 100 (S16).

When the answers to the implementation checklist questionnaire are received from the implementation management terminal 300, the cloud server 100 generates an implementation checklist confirmation document (S18). The implementation checklist confirmation document is saved in the customer DB 60.

Thereafter, the approver of the HACCP certification company requests reading of the implementation checklist confirmation document through the approver terminal 400 in order to confirm whether the HACCP certification requirements are implemented (S20).

When there is a request for reading from the approver terminal 400, the cloud server 100 provides the implementation checklist confirmation document saved in the customer DB 60 to the approver terminal 400.

When the implementation checklist confirmation document is approved by the approver terminal 400, an approval signal is transmitted to the cloud server 100.

When the approval signal is received from the approver terminal 400, the cloud server 100 generates an approval document by processing the implementation checklist confirmation document (S26). Thereafter, a person of the HACCP certification company, such as the implementation manager or the approver, etc., may download the approval document and may submit the approval document to the HACCP management agency.

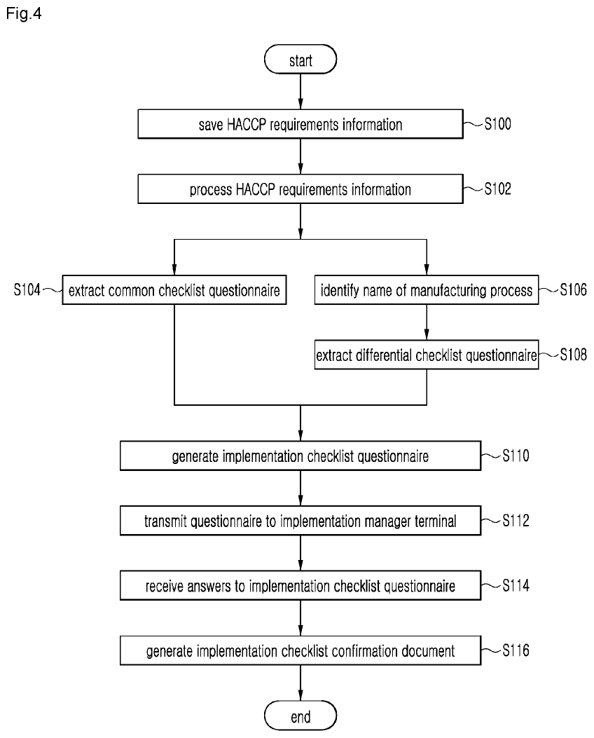

FIG. 4 illustrates a processing process for managing HACCP implementation check in the cloud server according to the present disclosure.

Referring to FIG. 4, the cloud server receives HACCP requirements information from the HACCP certification company and saves the same (S100), and prepares a process of generating an implementation checklist questionnaire for each HACCP certification company by processing the HACCP requirements information (S102).

The cloud server extracts a common checklist questionnaire from the pre-stored common checklist DB according to a task implementation designation schedule table of each customer included in the HACCP requirements information (S104). Simultaneously or sequentially, the cloud server identifies a name of each food manufacturing process (detection of foreign substances, detection of metal), based on the HACCP requirements information (S106), and extracts a differential checklist questionnaire from the differential checklist DB according to a result of the identification (S108).

When the common checklist questionnaire and the differential checklist questionnaire are extracted, the cloud server 100 generates an implementation checklist questionnaire therefrom (S110).

Next, the cloud server transmits the implementation checklist questionnaire to an implementation manager terminal which is designated when a HACCP implementation check service is subscribed to (S112). When answers to the implementation checklist questionnaire are received from the implementation manager terminal after the implementation checklist questionnaire is transmitted to the implementation manager terminal (S114), the cloud server generates an implementation checklist confirmation document by processing the implementation checklist questionnaire and the answers (S116).

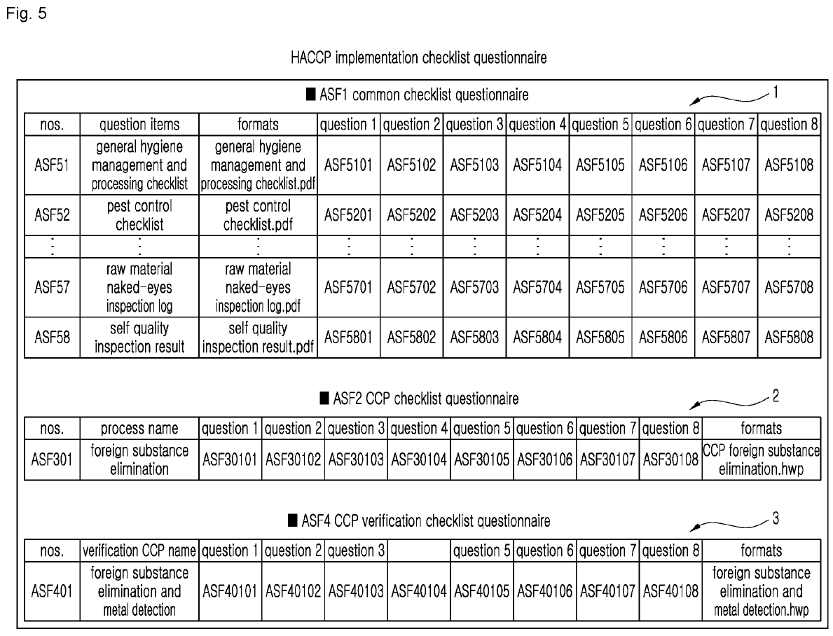

FIG. 5 illustrates a HACCP implementation checklist questionnaire according to the present disclosure.

Referring to FIG. 5, reference numeral 1 indicates a common checklist questionnaire, and reference numerals 2, 3 indicate differential checklist questionnaires. Specifically, reference numeral 2 indicates a differential checklist questionnaire having an answer record format to a question, and reference numeral 3 indicates a differential checklist questionnaire having a check format to a question.

The common checklist questionnaire is a questionnaire that is created in the form of a table for questions and answers by disassembling a common checklist. For example, a general hygiene management process checklist, which is one of the common checklists, has questions included therein disassembled into 8 questions and then is converted into a table format to allow respective questions and answers thereto to be recorded.

Likewise, a foreign substance elimination checklist, which is one of the differential checklists (CCP checklists), has questions included therein disassembled into 8 questions and then is converted into a table format to allow respective questions and answers thereto to be recorded.

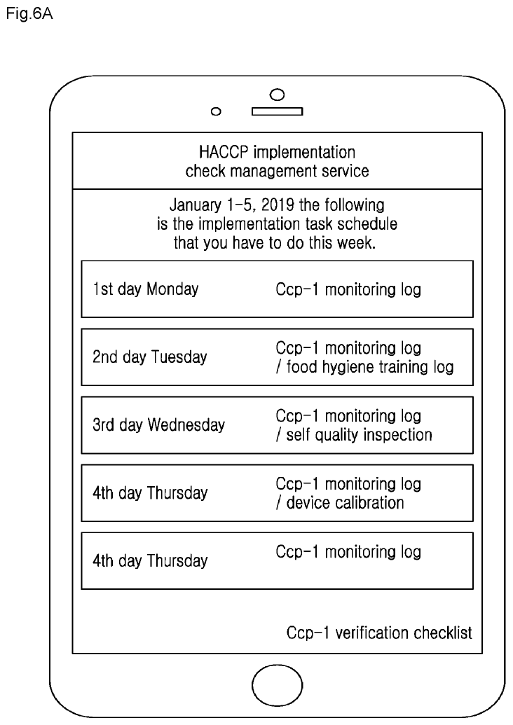

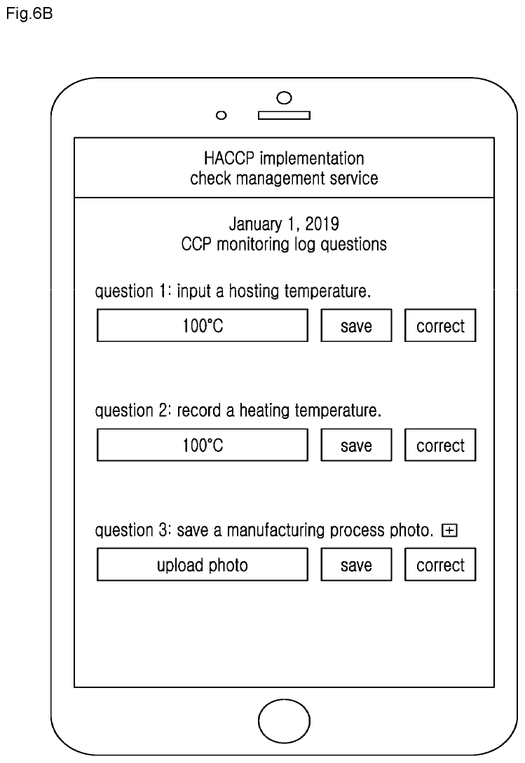

FIGS. 6A and 6B illustrates a screen displayed on the implementation manager terminal which receives a HACCP implementation check management service, respectively, according to the present disclosure.

Referring to FIGS. 6A-6B, the implementation manager terminal receives an implementation checklist questionnaire from the cloud server according to an implementation check date, and in this case, an application installed in the implementation manager terminal displays the screen as shown in FIGS. 6A-6B, respectively, by processing the implementation checklist questionnaire.

In view of FIG. 6A, a week implementation task schedule is displayed, and in view FIG. 6B, questions that should be recorded by monitoring on the day are displayed, respectively.

The implementation manager may identify the week implementation task schedule according to the implementation checklist questionnaire displayed on the implementation manager terminal, and may identify an implementation item that should be monitored on a daily basis, and may record and saved the monitored item.

In this case, when the implementation manager inputs and saves an answer to question 1 and then skips to question 3 without inputting and saving an answer to question 2 in view of FIG. 6B, an answer field to question 3 may be inactivated such that an answer cannot be inputted or a photo cannot be uploaded. This function is to prevent a problem that answers to all questions in the implementation checklist questionnaire are not recorded and the HACCP implementation requirements are not fulfilled.

The implementation manager may record and save the monitored items, and then, may transmit answers to the implementation checklist questionnaire to the cloud server through a cloud transmit button, although this operation is not illustrated.

The above description is merely an illustrative description of the present disclosure, and various changes may be made by those skilled in the art without departing from the technical concept of the present disclosure.

Therefore, embodiments disclosed in the detailed description of the present disclosure are not intended to limit the present disclosure. The scope of the present disclosure should be interpreted by the appended claims, and all technologies within the scope equivalent thereto should be interpreted as being included in the scope of the present disclosure.

What is claimed is:

1. A HACCP implementation check management method which is performed by a cloud server in a HACCP implementation check management system, the method comprising:
a step of generating and saving a common checklist questionnaire having a question-answer format by disassembling a common checklist;
a step of generating and saving a differential checklist questionnaire having a question-answer format by disassembling a differential checklist;
a step of generating an implementation checklist questionnaire from the common checklist questionnaire and the differential checklist questionnaire, on the basis of a task implementation designation schedule table for each customer included in HACCP requirements information of a HACCP certification company;
a step of transmitting the implementation checklist questionnaire to an implementation manager terminal of the HACCP certification company;
a step of receiving answers to the implementation checklist questionnaire from the implementation manager terminal, and generating and saving an implementation checklist confirmation document; and
a step of generating and saving an approval document regarding the implementation checklist confirmation document when the implementation checklist confirmation document is approved by an approver terminal of the HACCP certification company.

2. The method of claim 1, wherein the common checklist questionnaire or the differential checklist questionnaire is generated in the form of an audio file, and the implementation checklist questionnaire is provided to the implementation manager terminal in the form of an audio file.

3. The method of claim 1, wherein the implementation checklist questionnaire is generated and is transmitted to the implementation manager terminal every time an implementation check date comes according to the task implementation designation schedule table, or the implementation checklist questionnaire is generated and saved in advance with respect to all implementation check dates and is transmitted when a corresponding date comes.

4. An application for HACCP implementation check management which is saved in a computer-readable recording medium, the application performing:
a step of receiving an implementation checklist questionnaire comprising a common checklist questionnaire and a differential checklist questionnaire from a cloud server when an implementation check date comes;
a step of processing the received implementation checklist questionnaire, and providing implementation check questions and answer fields thereto; and
a step of transmitting answers to the implementation checklist questionnaire to the cloud server when the answers to the implementation checklist questionnaire are completed.

5. The application of claim 4, wherein, when all answers are not inputted in response to the implementation checklist questionnaire, the application does not proceed to a next step.

6. The application of claim 4, wherein the implementation check questions are outputted in the form of an audio.

7. The application of claim 4, further performing:
a step of receiving an implementation checklist confirmation document from the cloud server when the implementation checklist confirmation document saved in the cloud server is requested; and
a step of transmitting an approval signal to the cloud server when the approval of the received implementation checklist confirmation document is completed.

8. A HACCP implementation check management system comprising:
a cloud server configured to generate a common checklist questionnaire having a question-answer format by disassembling a common checklist, to generate and save a differential checklist questionnaire having a question-answer format by disassembling a differential checklist, and to generate an implementation checklist questionnaire from the common checklist questionnaire and the differential checklist questionnaire, on the basis of a task implementation designation schedule table for each customer included in HACCP requirements information of a HACCP certification company;
an implementation manager terminal configured to receive the implementation checklist questionnaire from the cloud server every time an implementation check date comes, and to transmit answers to the implementation checklist questionnaire to the cloud server; and
a computer of the HACCP certification company configured to connect to the cloud server and to transmit the HACCP requirements information of the HACCP certification company to the cloud server.

9. The system of claim 8, wherein the cloud server is configured to receive answers to the implementation checklist questionnaire from the implementation manager terminal and to generate and save an implementation checklist confirmation document,
wherein the system further comprises an approver terminal configured to request the implementation checklist confirmation document from the cloud server and to transmit an approval signal to the cloud server when the implementation checklist confirmation document is approved, and
wherein the cloud server is configured to generate an approval document regarding the implementation checklist confirmation document, on the basis of the approval signal.

10. The system of claim 8, wherein the cloud server is configured to generate the common checklist questionnaire or the differential checklist questionnaire in the form of an audio file, and to provide the implementation checklist questionnaire to the implementation manager terminal in the form of an audio file.
